(19) United States
(12) Patent Application Publication
(10) Pub. No.: US 2014/0271443 A1
(43) Pub. Date: Sep. 18, 2014

(54) High Glass Transition Lignins and Lignin Derivatives for the Manufacture of Carbon and Graphite Fibers

(71) Applicant: University of Tennessee Research Foundation, Knoxville, TN (US)

(72) Inventors: Darren A. Baker, Kingston, TN (US); Omid Hosseinaei, Knoxville, TN (US)

(21) Appl. No.: 14/215,453

(22) Filed: Mar. 17, 2014

Related U.S. Application Data
(60) Provisional application No. 61/794,000, filed on Mar. 15, 2013.

(51) Int. Cl. C01B 31/00; D01D 5/00; C07G 1/00

(52) U.S. Cl. CPC C01B 31/00; C07G 1/00; D01D 5/003
USPC 423/447.2; 530/500; 530/507; 264/433

(57) ABSTRACT

High glass transition temperature lignin derivatives and methods of making the same are disclosed herein. In addition, methods for making carbon nanofibers from the lignin derivatives is also provided. The lignin derivatives disclosed herein are suitable for electrospinning and provide increased efficiency in production of carbon nanofibers. The lignin derivatives may be obtained using the methods disclosed herein from pulping processes conducted on lignin stock material.

### RELATED APPLICATIONS

This application claims priority to U.S. Provisional Patent Application No. 61/794,000 filed on Mar. 15, 2013 and entitled “High Glass Transition Lignins and Lignin Derivatives for the Manufacture of Carbon and Graphite Fibers.” The entire contents of the above-identified application are hereby fully incorporated herein by reference.

### TECHNICAL FIELD

The present disclosure relates to lignin derivative compositions, carbon nanofibers derived therefrom, and methods of making and using the same. More particularly, the present disclosure relates to high glass transition lignin derivatives, carbon nanofibers derived therefrom, and method of making and using the same.

### BACKGROUND

Study of the conversion of biomass into fuels, chemicals and other value-added materials is increasing rapidly for the replacement of petroleum-based products towards cost reduction and global sustainability. Among biomass polymers, lignin is the second most abundant behind cellulose and is about 16-35% dry mass of biomass. The paper industry is currently the main producer of lignin as a by-product of pulping processes. Different pulping processes are used for producing pulp with differing properties, of which the kraft process is dominant. The lignin by-product is used mainly as an energy source and has therefore been assigned a low value. Low-cost carbon fibers are one of the potential value-added materials which can be manufactured using lignin (Uraki et al. Carbon (1995), 40(15):2913-2920; Kadla et al. Carbon (2002) 48:696-705; Baker et al. Journal of Applied Polymer Science (2012), 124(1):227-234. Impurities, low molecular weight and glass transition temperatures are factors which negatively affect carbon fiber production from lignin, which need to be addressed before commercialization is possible.

The manufacture of carbon nanofiber mats via electrospinning has been the focus of recent work. Electrospun carbon nanofibers have potential applications in areas such as filtration, energy storage and nanocomposites and this is due to their high surface-to-volume ratio and strength. Commercialization can be achieved provided the carbon nanofibers can be manufactured quickly and efficiently. (Huang et al. Composites Science and Technology (2003), 63(15):2223-2253. However, previous studies on the manufacture of lignin based carbon nanofibers have required treatment times of between three days and two weeks for conversion of the nanofibers into carbon. (Ruiz-Rosas et al. Carbon (2010), 40(15):2913-2920.

### SUMMARY

In on aspect, the present disclosure is directed to lignin derivatives having a glass transition temperature. The lignin derivatives disclosed herein may be used, for example, to produce carbon nanofibers within hours as opposed to days as required by existing processes. In certain example embodiments, the lignin derivative has a glass transition temperature (T_{g}) of at least 130° C. In certain other example embodiments, the lignin derivative has a glass transition temperature of at least 155° C. The ash content of the lignin derivatives disclosed herein may be between approximately 0.01% and approximately 0.60%.

The lignin derivatives may derived from different lignin source materials. For example, the lignin source material may be derived from a pulping process conducted on a lignin feed stock material. In certain example embodiments, the pulping process is a kraft pulping process or an organosolv pulping process. In certain example embodiments, the lignin feedstock material may be a softwood lignin feedstock material, a hardwood lignin feedstock material, an annual fiber feedstock material, or a combination thereof. In certain other example embodiments, the lignin feedstock material is switchgrass, poplar, pine, or a combination thereof.

In another aspect, the present disclosure is directed to a method for making lignin derivatives from lignin source materials. In one example embodiment, the method comprises washing a lignin source material with water or acidified water to generate a purified lignin portion, extracting the purified lignin portion with a solvent to generate a lignin derivative extract, and filtering and recovering the lignin derivative extract to generate a final lignin derivative. In certain example embodiments, the solvent comprises methanol, methylene chloride, dimethyl formamide, dimethyl acetamide, ethanol, propanol, diethyl ether methanol, or a combination thereof. In another example embodiment, the method comprises washing a lignin source material with water or acidified water to generate a purified lignin portion, extracting the purified lignin portion with a first solvent to generate a first purified lower T_{g} lignin extract contained in the first solvent, filtering and recovering the first purified lignin extract to generate a lower T_{g} lignin derivative, extracting the first lower T_{g} lignin derivative with a second solvent to generate a high T_{g} lignin derivative extract, filtering and recovering the high T_{g} lignin derivative extract to generate a high T_{g} lignin derivative, wherein the high T_{g} lignin derivative has a higher T_{g} than the low T_{g} lignin derivative. In certain example embodiments, the first solvent comprises methanol, methylene chloride, dimethyl formamide, dimethyl acetamide, ethanol, propanol, diethyl ether methanol, or a combination thereof, and the second solvent comprises a mixture of methanol and methylene chloride. In certain example embodiments, the second solvent comprises a 7/30 v/v mixture of methanol to methylene chloride.

In another aspect, the present disclosure is directed to lignin derivative made using one or both of the above methods.

In another aspect, the present disclosure is directed to methods of making carbon nanofibers from the lignin derivatives disclosed herein. In on example embodiment, the method for making carbon nanofibers comprises electrospinning a concentration of the lignin derivative dissolved in an electrospinning solution to generate lignin nanofibers, thermostabilizing the lignin nanofibers, and carbonizing the lignin nanofibers to generate carbon nanofibers. In certain example embodiments, the method may further comprise graphitizing the carbon nanofibers to generate graphite nanofibers. In certain example embodiments, the electrospinning solution may comprise approximately 75% dimethyl formamide and approximately 25% methanol. In certain example embodiments, the lignin derivative concentration may be between approximately 40% and approximately 50%. In certain other example embodiments, the lignin derivative concentration is approximately 42%. In certain example embodiments, the carbon nanofibers produced by the above method may have a diameter of between 25 nm and 5 microns. The nanofibers may be made in the form of carbon nanofibers mats. In certain example embodiments, the carbon nanofibers mats may have a thickness of between 100 μm to 500 μm. In certain example embodiments, the lignin nanofibers are thermostabilized by heating the lignin derivatives to a temperature between 160 to 250° C. at a rate between 0.1 and 100° C./min. In certain other example embodiments, the lignin nanofibers were carbonized by heating to a temperature between 800 to 1250° C. at a rate of 10° C./min and holding for 2 minutes.

In another aspect, the present disclosure is related to carbon nanofibers made using the lignin derivatives and methods disclosed herein, as well as compositions comprising the carbon nanofibers disclose herein.

These and other aspects, objects, features, and advantages of the example embodiments will become apparent to those having ordinary skill in the art upon consideration of the following detailed description of illustrated example embodiments, which include the best mode of carrying out the invention as presently claimed.

### BRIEF DESCRIPTION OF THE DRAWINGS

FIG. 1 is diagram representing the manufacture of carbon nanofibers from lignin and a comparison of potential processing times for the use of low T_{g} (top; e.g. T_{g}<130° C.) and high T_{g} (bottom; e.g. T_{g}>155° C.) lignins.

FIG. 2 is a graph showing thermogravimetric (TG) and derivative thermogravimetric (DTG) curves of SWKL, SWKL-P, and SWKL-R2 under inert atmosphere.

FIG. 3 are SEM micrographs and diameter distributions of carbon nanofibers from solutions with different lignin concentrations (w/w); (a) 35.7%, (b) 38.5%, (c) 41.7%, and (d) 45.5%.

FIG. 4 are SEM micrographs of a cross section of carbon nanofibers from 41.7% w/w lignin solution; (a) at lower magnification, and (b) at higher magnification.

FIG. 5 are SEM micrographs of carbon nanofibers from a 41.7% w/w lignin solution stabilized at different heating rates (° C./min); (a) 0.1, (b) 1, (c) 10, and (d) 20.

FIG. 6 is a graph showing TG and DTG curves of green and stabilized nanofibers (41.7% w/w lignin solution).

FIG. 7 is a graph of IR spectra of nanofibers in green and stabilized at different heating (41.7% w/w lignin solution).

FIG. 8 is a SEM micrograph of carbon nanofibers from switchgrass lignin.

FIG. 9 is a SEM micrograph of a carbon nanofibers mat from poplar lignin.

FIG. 10 is a SEM micrograph of carbon nanofibers from another poplar lignin illustrating the use of an intermediate T_{g} to produce fused fibrous mats.

### DETAILED DESCRIPTION

Embodiments herein provide lignin derivative compositions, and methods for making such compositions. In addition, embodiments provided herein provide lignin-based carbon nanofibers made from the lignin derivative compositions disclosed herein, and methods of making the same.

In certain example embodiments, a lignin derivative and methods for deriving the lignin derivative from lignin source materials are provided. The lignin source materials can include industrial lignin source materials such, but not limited to, lignin by-products of pulping processes. In certain example embodiments, the lignin source material is a lignin by-product of a kraft pulping process or an organosolv pulping process. The lignin may be derived from softwood lignin feedstock materials, hardwood lignin feedstock materials, annual feedstock lignin materials or a combination thereof.

Example hardwood feedstocks species selected from one or more of the following hardwood trees species selected from the following families; Adoxaceae, Altingiaceae, Anacardiaceae, Apocynaceae, Aquifoliaceae, Araliaceae, Betulaceae, Bignoniaceae, Cactaceae, Cannabaceae, Cornaceae, Dipterocarpaceae, Elbenaceae, Ericaceae, Eucommiaceae, Fabaceae, Fagaceae, Fouquieriaceae, Hammamelidaceae, Juglandaceae, Lauraceae, Lecythidaceae, Lythraceae, Malvaceae, Meliaceae, Moraceae, Myrtaceae, Nothofagaceae, Nyssaceae, Oleaceae, Paulowniaceae, Plantanaceae, Rhizophoraceae, Rosaceae, Rubiaceae, Rutaceae, Salicaceae, Sapindaceae, Sapotaceae, Simaroubaceae, Theaceae, Thymelaeaceae, Ulmaceae, Verbenaceae, Agavaceae, Arecaceae, Laxmanniaceae, Poaceae, Ruscaceae, Annonaceae, Magnoliaceae, Myristicaceae, Ginkgoaceae, Cycadaceae, and Zamiaceae.

Example softwood feedstocks include tree species selected from one or more the following families; Araucariaceae, Cupressaceae, Pinaceae, Podocarpaceae, Sciadopityaceae, and Taxaceae.

Example annual fiber feedstocks include lignins derived from annual plants that complete their growth in one growing season such as flax, cereal straw (wheat, barley, oats), sugarcane, rice, corn, hemp, fruit pulp, alfa grass, switchgrass and combinations and hybrids thereof.

In certain example embodiments, the lignin feedstock is poplar, pine, or switchgrass. In certain other example embodiments, the lignin feedstock is a commercially available industrial lignin.

The lignin derivatives of the present invention have a glass transition temperature (T_{g}) of at least approximately 110 to approximately 200° C. In certain embodiments, lignin derivatives of the present invention have a glass transition temperature of at least approximately 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172 173, 174, 175, 176, 177, 178, 179, 180, 181, 182, 183, 184, 185, 186, 187, 188, 189, 190, 191, 192, 193, 194, 195, 196, 197, 198, 199 or 200° C. In certain example embodiments the lignin derivate has a glass transition temperature of at least approximately 130 to approximately 160° C. In certain example embodiments, the lignin derivate has a glass transition temperature of at least approximately 130° C. In certain example embodiments the lignin derivate has a glass transition temperature of at least approximately 155° C. In certain other example embodiments, the lignin derivative has a glass transition temperature is at least 130° C. In certain other example embodiments, the glass transition temperature is at least 155° C. Example methods for determining the glass transition temperature of the lignin derivative are described in detail in the Example section below.

The lignin derivatives of the present invention have an ash content of between approximately 0.01% and 0.60%. In certain example embodiments, the lignin derivatives have an ash content of less than approximately 0.60%, 0.55%, 0.50%, 0.45%, 0.40%, 0.35%, 0.30%, 0.25%, 0.20%, 0.15%, 0.10%, or 0.05%. In certain other example embodiments the ash content is less than 0.60%. In certain example embodiments, the ash content is approximately 0.10% or less. Example methods for determining the ash content of the lignin derivative are described in detail in the Example section below.

Methods for making the lignin derivatives disclosed herein comprise washing the lignin source material with water or acidified water to generate a purified lignin portion. The lignin source material may first be stirred rapidly at 20, 30, 40, 50, 60, 70, 80, 90, 100, or 110° C. for 0.5, 1, 1.5, 2, 2.5, 3.0, 3.5, or 4 hours. In certain example embodiments, lignin source material may first be stirred rapidly at or around 80° C. for one to two hours. The resulting suspension may then be cooled to room temperature and the solids filtered. The process may be repeated multiple times until the filtrate is a very pale yellow. In certain example embodiments, the wash step may be repeated about three times. The resulting purified lignin is then vacuum dried and solvent extracted in a solvent such as methanol, methylene chloride, dimethyl formamide, dimethyl acetamide, ethanol, propanol, and/or diethyl ether. The purified lignin may be sequentially extracted with solvents to recover lignins with suitable glass transition temperatures. In certain example embodiments, the purified lignin is sequentially extracted until the solvent contains less than about 0.25 g/L of recoverable solids. In certain other embodiments, the lignin is sequentially extracted until the solvent contains less than about 0.15, 0.20, 0.25, 0.30, or 0.35 g/L of recoverable solids. The solvent extract is filtered and vacuum dried to generate a first lignin derivative portion. In certain example embodiments, the first lignin derivative portion is the final lignin derivative.

In certain example embodiments, the first lignin derivative portion may then be extracted with a second solvent. The second solvent may be a mixed solvent, such as a mixture of methanol and methylene chloride. In certain example embodiments, the mixture of methanol to methylene chloride is 70/30 v/v. The first lignin derivative portion may be sequentially extracted in the second solvent. In certain example embodiments, the first lignin derivative is sequentially extracted until the extract contains less than 0.25 g/L of recoverable solids. The first lignin derivative extract is then vacuum filtered to generate a final lignin derivative that has a higher T_{g} than the first lignin derivative portion.

The lignin derivatives disclosed herein are suitable for generating relatively uniform carbon nanofibers. In certain example embodiments the carbon nanofibers derived from the lignin derivatives disclosed herein have a diameter of 25 nm to 5 microns. In certain example embodiments the carbon nanofibers have a diameter between 10 and 100 nm, between 100 and 200 nm, between 200 and 300 nm, between 300 and 400 nm, between, 10 and 100 nm, between 100 and 300 nm, between 300 and 500 nm, between 300 and 600 nm, between 300 and 700 nm, between 300 and 800 nm, between 300 and 900 nm, between 500 and 900 nm, between 500 and 800 nm, between 500 and 700 nm, between 500 and 600 nm, between 300 and 400 nm, between 400 and 500 nm, between 600 and 700 nm, between 700 and 800 nm, between 800 and 900 nm, between 500 nm and 5 microns, 600 nm and 5 microns, 700 nm and 5 microns, 800 nm and 5 microns, 900 nm and 5 microns, 1 micron and 5 microns, 2 microns and 5 microns, 3 microns and 5 microns, or 4 microns and 5 microns.

In certain example embodiments, the carbon nanofibers are prepared from the lignin derivatives disclosed herein using an electrospinning process. A concentration of the lignin derivatives are first dissolved in an electrospinning solution. In certain example embodiments, the lignin derivative composition is dissolved in a mixture of methanol and dimethylformamide. In certain example embodiments, the mixture comprises 75% dimethylformamide and 25% methanol. Example electrospinning conditions are described in detail in the Example section below.

The concentration of lignin derivative added to the electrospinning solution may be between 20% and 60%, between 20% and 30%, between 30% and 50%, between 30% and 40%, between 40% and 50%, or between 50% and 60%. In certain example embodiments the lignin derivative concentration is between 40% and 45%. In certain other example embodiments, the lignin derivative concentration is 42%.

In certain example embodiments, the electrospinning process produces lignin nanofibers mats. The nanofibers mats may have a thickness of between approximately 100 μm to 500 μm. In certain example embodiments, the nanofiber mats may have a thickness between 100 to 300 μm, between 100 to 400 μm, between 200 to 500 μm, between 200 to 400 μm, or between 200 and 300 μm.

After electrospinning the lignin derivatives into lignin nanofibers, the lignin nanofibers are thermostabilized. Example thermostabilizition conditions described in detail in the Examples section below.

After thermostabilizition, the lignin nanofibers are carbonized and/or graphitized to produced lignin-based carbon nanofibers. Example carbonization conditions are described in detail in the Example section below.

The following examples are provided to illustrate certain particular features and/or embodiments. These examples should not be construed to limit the invention to the particular features or embodiments described.

### EXAMPLES

### Example 1

### Materials and Methods

### Lignin Source Material

A commercial softwood kraft lignin, Indulin AT was obtained from MeadWestvaco (Charleston, S.C.) as a dry powder Prior to any characterization and/or processing, lignin samples were homogenized and dried under vacuum at 80° C. for at least 24 hours to minimize moisture content. All solvents used in the study were of ACS grade and were obtained from Thermo Fisher Scientific Inc. (Pittsburgh, Pa.). Thermal analysis gases were supplied by Airgas Inc. and included Nitrogen (99.999%, UHP) and Air (Zero grade).

### Refined Lignin Preparation

Indulin AT (SWKL; 1800 g) was stirred rapidly in deionized water (12.0 L) at 80° C. for 2 hours. The suspension was cooled to room temperature and then solid filtered at the pump. The recovered solid was air dried at the pump and the procedure repeated until the filtrate was a very pale yellow, indicating the removal of less than 0.1 g/L of solids (three washes, total 18 L). The purified lignin (SWKL-P) was then dried (80° C., 24 hours, vacuum), giving a yield of 1388 g (77.1%). SWKL-P was then sequentially solvent extracted. SWKL-P (1000 g) was first extracted with methanol until further treatment gave liquors containing less than 0.25 g/L of recoverable solids to ensure continuity in lignin sample preparation for potential replicate experiments; each methanol extract was filtered at the pump and the filtrates combined. Evaporation of the filtrates, after drying (80° C., 24 hours, vacuum), gave lignin derivative, SWKL-1, in 39.7% yield (397 g). The solids, recovered at the pump, were then extracted using a 70/30 v/v. mixture of methanol and methylene chloride until further treatment gave liquors containing less than 0.25 g/L of recoverable solids; each 70/30 extract solution was filtered at the pump and the filtrates combined. Evaporation of the filtrates, after drying (80° C., 24 hours, vacuum), gave a second lignin derivative, SWKL-2, in 51.5% yield (515 g). Insoluble solids recovered at the pump in 8.8% yield (96.1 g).

### Lignin Analysis

The ash contents of SWKL, SWKL-P, SWKL-1 and SWKL-2 lignin were determined by treating each sample in triplicate at 575° C. for 24 hours according to the NREL/TP-510-42622 standard method defined by the National Renewable Energy Laboratory. Determination of carbohydrate and specific lignin components were made by measurements in accordance with the NREL/TP-510-42618 standard method also defined by the National Renewable Energy Laboratory. In brief, each lignin was hydrolyzed using a two-stage process using sulfuric acid comprising 1 hr at 30° C. with 72% sulfuric acid, and then 1 hr at 121° C. with 4% sulfuric acid. The resultant hydrolysis products were filtered at the pump, and the acid-insoluble lignin fraction yield was determined gravimetrically. The acid-soluble lignin fraction was quantified by ultraviolet (UV) measurements (Lambda 650, PerkinElmer, Shelton, Conn.). Any saccharides to be found resulting from the acid hydrolysis within the soluble liquid fraction were analyzed by high-pressure liquid chromatography (HPLC, Flexar, PerkinElmer). The HPLC was equipped with an Aminex HPX-87P column (Bio-Rad) and a refractive index detector (Series 200a, PerkinElmer) and separations performed using a 0.25 ml/min flow rate and Milli-Q deionized water, with a column temperature of 85° C.

Determination of the structural composition of each lignin was determined by Pyrolysis-Gas Chromatography/Mass Spectrometry (Py-GC/MS). The apparatus consisted of a Pyroprobe 5000 Series pyrolysis column (CDS Analytical Inc.) directly mounted to a Clarus 600 GC (PerkinElmer Inc.) and coupled with a Clarus 600T MS (PerkinElmer Inc.). Rapid pyrolysis of each sample was accomplished via the manual injection of ˜0.5 mg samples contained in small metal ampules. Prior to sample injection, the pyrolysis column was initially set at 50° C. for 5 seconds to allow sample injection and then ramped at a rate of 1000° C./second to 600° C. and held at that temperature for one minute to pyrolyze the sample. The resulting vapors were transported at 300° C. to the GC and a portion (25:1 ratio) was separated on a VF1701 ms column (Agilent) at 280° C. using a carrier He gas flow of 1 ml/min. The separated components were transported at 200° C. to the MS and spectra were recorded using electron ionization (70 eV; ion source 200° C.) using an m/z range of 40-550 amu. Identification of individual fragmentation lines were determined by comparison with currently accepted data contained in the NIST mass spectral library and also the published literature.

The chemical fingerprints of finely divided lignin samples were measured by FTIR (ATR) spectroscopy measurements. Ten independent sample measurements were made for each sample, over the range 4000 to 600 cm⁻¹, with 4 cm⁻¹ resolution and a 32 scan collection frequency. The multivariate statistical analysis method of principal component analysis (PCA) was used to measure differences between the samples according to specific spectral features. PCA is a projection method that allows the visualization of complex data by removing redundancy and noise variability from the data. The purpose of PCA is to compress the spectral data set X (n objects, m variables) into its most relevant factors known as principal component (PC) of X. The samples pattern of the data set can then be represented in a two-main factor plot called the score plot. The information about the relationship between the original variables (wavenumber) and the principal components (PCs) is given by a plot called loadings plot. When compared with their corresponding score plots, loadings show how much each variable contributes to each PC. Prior to analysis, the spectral data were processed using Unscrambler (CAMO, Woodbridge, N.J.). The results from the PCA are displayed in scores and loadings plots. The scores plot describes the relation between samples and helps visualize any clustering or trends in the data set in the new system of axes of principal components (PCs). The loadings plot presents the relationship between the wavenumbers and determines which spectral region contributed the most to the separation and/or classification of the samples, and therefore allows spectrographic comparison of what appear to be similar sample spectra.

The carbon, hydrogen, nitrogen and sulfur contents of each lignin sample were measured by elemental analysis using a PerkinElmer Inc. 240011 CHNS/O combustion elemental analyzer (Waltham, Mass.). Values for carbon, hydrogen, nitrogen and sulfur content were determined using a sample mass of approximately 2 mg in triplicate. The particular method used was optimized for the determination of lower (˜1%) sulfur contents. Samples were dried at 80° C. under vacuum prior to weighing, then weighed and placed in tin elemental analysis cups, sealed and stored in a desiccator until measurement.

### Lignin Thermal Properties

The softening and melt behaviors of SWKL, SWKL-P, SWKL-1 and SWKL-2 were characterized optically using a Fisher-Johns melting point apparatus. A small amount of dried lignin sample was placed between two microscope cover slips and placed on the heating platform of the instrument. The temperature range for the softening point (Tₛ) was determined at a higher heating rate. A subsequent test was then performed using a lower heating rate of 1-3° C./min at about 20° C. from the expected transition temperature. Temperature values were recorded when softening (Tₛ) and melt flow (T_{flow}) were observed; T_{flow} was determined to be the temperature at which compression of slips caused the sample to flow.

The influence of purification and then sequential solvent extraction on the thermal decomposition behavior of the lignin samples were studied using a PerkinElmer Pyris 1 thermogravimetric analyzer (TGA). TGA was conducted using 5 mg of material of each sample, which was heated from 100° C. to 950° C. at a heating rate of 10° C./min under a nitrogen atmosphere (10 mL/min), and with two further replicates. The thermal decomposition temperature (T_{d,max}) was recorded as the temperature at which the rate of mass loss was at a maximum. The onset of thermal decomposition (T_{d,onset}) was recorded at the intersect between two tangents; the first tangent being drawn from T_{d,max}, and the second from the slope of the baseline prior to any thermal decomposition or volatile ejection. The residual char/carbon yield at 950° C. was also calculated.

The glass transition temperatures of the lignins were determined using a PerkinElmer Pyris Diamond differential scanning calorimeter (DSC). Since T_{g} measurements of high T_{g} lignins can be difficult due to volatile material evaporation and/or chemical changes within lignins at elevated temperatures a new method was devised. Before final evaluation of lignin T_{g} was determined, an approximate T_{g} offset was measured in which 2 mg sample (in an aluminum pan) was heated at a rate of 500° C./min under nitrogen (UHP, 20 mL/min) to 140° C. and held at that temperature until the change in heat flow was zero, to expel any moisture regain in the sample. The sample was then heated to 240° C. at 500° C. and rapidly cooled to 0° C. to quench the lignin. A preliminary T_{g} offset was then recorded by heating the sample to 240° C./min at 100° C./min and the preliminary offset used as a guide for selecting conditions for the subsequent DSC measurement.

The T_{g} was then measured using new samples, and in duplicate in the following manner. 2 mg of lignin was heated at a rate of 500° C./min under nitrogen (UHP, 20 mL/min) to 140° C. and held at that temperature until the change in heat flow was zero, to expel any moisture regain in the sample. The sample was then heated to a temperature of 40° C. higher than the offset measured previously and rapidly cooled to 0° C. to quench the lignin; this was done to prevent loss of volatile lignin components in low T_{g} samples (T_{g}<ca. 120° C.) and also crosslinking/degradation of the lignin in high T_{g} samples (T_{g}>ca. 155° C.). Once quenched, the sample was heated to a temperature of 60° C. higher than the offset measured previously at a rate of 100° C./min (the instrument was calibrated for this rate). The T_{g} (half-height) and enthalpy were obtained from this thermogram and an average of the duplicate measurements for both calculated.

### Electrospinning

After preliminary investigations, electrospinning solutions were prepared of differing lignin concentration (35.7, 38.5, 41.7, 45.5 and 50.0% w/w.; i.e. 50.0% w/w is 10 g lignin in 10 g solvent) by dissolving HWKL-2 in a volume mixture of 75% dimethylformamide (DMF) and 25% methanol (MeOH). Since the solutions were viscous and very dark, complete dissolution was confirmed by viewing drops placed between slides under a microscope. These solutions, in turn, were electrospun by passing the solution at a rate of 0.5 ml/hour through a needle with an orifice using a syringe and syringe pump apparatus. A potential difference of 15 kV was applied between the needle orifice and a grounded and rotating (50 rpm) aluminum cylinder (3 in. diameter, 4 in. width) used to collect nanofiber mats at a distance of 20 cm from the orifice.

### Thermostabilization and Carbonization

Oxidative thermostabilization of the electrospun lignin nanofiber mats was done by heating the samples up to 250° C. using various rates (0.1, 0.2, 0.5, 1, 3, 5, 10 and 20° C./min) and then by holding at that temperature for 30 min. in a Lindberg/Blue M forced air convection oven (Thermo Scientific, Watertown, Wis.). The oxidatively thermostabilized lignin nanofiber mats were then carbonized in a 1 in. Lindberg/Blue M tube furnace (Thermo Scientific, Watertown, Wis.) by heating to 950° C. at a rate of 10° C./min and then holding at that temperature for 2 min. Nitrogen (200 ml/min; UHP) was used as the inert gas. In each case oxidative thermostabilization and carbonization yields were recorded.

### Fiber Characterization

The morphologies of the electrospun lignin nanofibers, oxidatively thermostabilized lignin nanofibers, and the carbon nanofibers, were evaluated by scanning electron microscopy (SEM) on an LEO 1525 (Carl Zeiss SMT AG, Germany). Fiber diameters were measured from the SEM micrographs as an average of 100 random fibers measurements by using image analysis software (ImageJ, NIH, Bethesda, Md.).

Carbon, hydrogen, nitrogen and sulfur contents of electrospun lignin nanofiber, oxidatively thermostabilized lignin nanofiber, and the carbon nanofiber sample mats were measured by elemental analysis as described above. The particular method used was optimized for carbon sample measurement, as required, to ensure complete combustion according to manufacturer recommendations. All samples were dried at 80° C. under vacuum prior to weighing, then weighed and placed in tin elemental analysis cups, sealed and stored in a desiccator until measurement.

FTIR spectra of both lignin nanofibers and oxidatively thermostabilized lignin nanofibers were obtained and analyzed as described above.

Thermogravimetric analysis (TGA) measurements were performed to investigate the thermal stability of lignin and oxidatively thermostabilized nanofiber mats using the same method described above. However, owing to the low density of the spun fiber mats, the sample mass was reduced to about 2 mg.

### Results

### Lignin Analysis

Indulin AT (SWKL) was purified for this study by simple water extraction to give SWKL-P in 77.1% yield. SWKL-P was then sequentially solvent extracted to give SWKL-R1 in 39.7% yield, SWKL-R2 in 51.5% yield, and a residual insoluble/infusible component in 8.8% yield (discarded). The particular method used differed from previous literature so that continuity in lignin properties could be maintained for the repeatability of experiments. In this respect, more than 20 kg of SWKL was purified for downstream solvent extraction experiments so that lignin derivatives with differing properties are provided for selected products; in this case electrospun nanofibers.

The purity of SWKL-P was compared to that of SWKL by measurement of their compositions (Table 1) by NREL protocols as described earlier.

TABLE 1
Structural composition of lignins used and prepared for the study

| | | SWKL | SWKL-P | SWKL-1 | SWKL-2 |
|---|---|---|---|---|---|
| Composition | Component | (%) | (%) | (%) | (%) |
| Ash | ~ | 2.73 (0.03)^{a} | 0.56 (0.03) | 0.21 (0.04) | 0.49 (0.02) |
| Cellulose | Glucose | 0.05 (0.01) | 0.00 (0.00) | 0.00 (0.00) | 0.00 (0.00) |
| Hemicellulose | Xylan | 0.26 (0.01) | 0.10 (0.02) | 0.00 (0.00) | 0.00 (0.01) |
| | Galactan | 0.37 (0.00) | 0.16 (0.05) | 0.00 (0.03) | 0.00 (0.01) |
| | Aribinan | 0.14 (0.02) | 0.07 (0.01) | 0.00 (0.02) | 0.00 (0.01) |
| | Mannan | 0.00 (0.00) | 0.00 (0.00) | 0.00 (0.00) | 0.00 (0.00) |
| | Total | 0.76 (0.00) | 0.33 (0.00) | 0.00 (0.00) | 0.00 (0.00) |
| Lignin | Acid soluble | 2.90 (0.14) | 1.21 (0.04) | 1.56 (0.10) | 0.46 (0.01) |
| | Acid insoluble | 91.57 (0.13) | 96.01 (0.11) | 96.95 (0.08) | 97.66 (0.06) |
| | Total | 94.48 (0.18) | 97.23 (0.07) | 98.54 (0.10) | 98.12 (0.04) |
| Mass Balance | ~ | 98.02 | 98.12 | 98.75 | 98.61 |

^{a}Standard deviation shown in parenthesis.

Aqueous purification of SWKL resulted in a lignin with a substantially reduced ash content of 0.56% compared to 2.73%; a reduction of almost 80%. Sequential solvent extraction resulted in a SWKL-1 derivative with an ash content of 0.21%, and the 70/30 methanol/methylene chloride extraction resulted in a SWKL-2 derivative with an ash content of 0.49%. SWKL-1 and SWKL-2 ash contents relative to SWKL were 7.7% and 17.9%, respectively. Similarly the hemicellulose content was also reduced to 0.33% for SWKL-P in comparison to 0.76% in the original SWKL lignin and the sequential solvent extractions essentially eliminated hemicelluloses. This indicated that while free sugars (hemicellulose based) were possibly eliminated during the aqueous purification, substantial hemicellulose materials remained and were bound to the lignins. However, the lignin-co-hemicellulose polymers were not dissolved in the solvents and most likely remained in the insoluble residue. A small amount of cellulose (perhaps as glucose) was recorded in SWKL and aqueous purification removed it. The overall purity of each lignin when normalized for 100% mass balance was: 96.6% for SWKL; 99.1% for SWKL-P; 99.8% for SWKL-1; and 99.5% for SWKL-2; the main impurities for SWKL-1 and SWKL-2 being ash content.

Elemental composition of lignin samples showed slightly increase in carbon content and decreases in percentage of nitrogen and sulfur after extraction (Table 2).

TABLE 2
Elemental composition of lignins used in the study

| Lignin | C (%) | H (%) | N (%) | S (%) |
|---|---|---|---|---|
| SWKL | 64.4 (0.1) | 5.45 (0.24) | 0.48 (0.06) | 1.35 (0.06) |
| SWKL-P | 65.5 (0.3) | 5.76 (0.07) | 0.30 (0.08) | 1.15 (0.04) |
| SWKL-1 | 67.4 (0.2) | 6.05 (0.02) | 0.23 (0.01) | 1.20 (0.01) |
| SWKL-2 | 67.2 (0.1) | 5.96 (0.06) | 0.31 (0.02) | 1.00 (0.01) |

^{a}Standard deviation shown in parenthesis.

Nitrogen comes mainly from extractives such as proteins and sulfur and arises due to the use of sodium sulfide in the kraft process which causes substantial sulfur to be bound to the lignin.

### Lignin Thermal Properties

Comparison of the lignins DSC and FJ measurements showed that both the purification and the sequential solvent extraction provided samples with differing glass transition temperatures (T_{g}), heat capacity changes associated with T_{g} (ΔCₚ), softening temperatures (TO, and melt flow temperatures (T_{f}). The original lignin, SWKL, had a broad T_{g} of 148° C. with a relatively low enthalpy (0.311 Wg⁻¹) which indicated that the lignin was of relatively high polydispersity and also contained a substantial amount of impurities and infusible lignin materials. This was consistent with the analytical data for SWKL and the subsequent extractions that had given a residual insoluble and infusible component. Furthermore, the softening temperature (Tₛ) was 184° C. which was 36° C. greater than T_{g} and incomplete, indicating substantial polydispersity. Upon purification, SWKL-P increased in both T_{g} (155° C.) and Tₛ (192° C.) indicating that some smaller, plasticizing contaminants (possibly extractives and oligomeric lignins) had been removed from SWKL during purification at 80° C. The slightly increased ΔCₚ of 0.317 Wg⁻¹ indicated that there was a slight increase in material that was able to experience a T_{g} in comparison to SWKL; this was consistent with the comparative purity data of SWKL-P and SWKL.

The particular solvents used to refine SWKL-P were chosen so that a high yield of high T_{g} lignin would result for the purpose of electrospinning nanofibers. Therefore SWKL-P was first extracted to remove low molecular weight lignin components (SWKL-1; with potential use for melt spun carbon fibers), and then extracted to remove the desired higher molecular weight lignin (SWKL-2), therefore excluding insoluble/infusible components. Removal of the low molecular weight fraction from SWKL-P gave SWKL-1 which had a T_{g} of 117° C. and a Tₛ of 138° C., and were therefore reduced in comparison, while ΔCₚ had increased to 0.418 Wg⁻¹ confirming that infusible components no longer contributed to the T_{g} measurement. A difference of 21° C. was recorded between Tₛ and T_{g} indicating SWKL-1 had reduced polydispersity in comparison to SWKL-P. Extraction of the desired fraction, SWKL-2, from SWKL-P provided a lignin derivative with a T_{g} of 182° C. and a Tₛ of 230° C., and were therefore increased in comparison to the same measurements for SWKL-P. In addition, ΔCₚ also increased to 0.398 Wg⁻¹ confirming that infusible components did not contribute to the T_{g} measurement. An increased difference of 48° C. was recorded between Tₛ and T_{g} which could indicate that SWKL-2 had an increased polydispersity in comparison to SWKL-P. However, since lignins typically undergo oxidative thermostabilization at appreciable rates above around 175° C., the measurement of Tₛ (230° C.) by FJ (under air) was difficult, and this measurement was therefore unreliable.

Since electrospinning is a solution based fiber forming process, the high T_{g} and Tₛ of SWKL-2 are desirable since the molecular weight of polymers influences polymer chain entanglements in electrospun solutions, with increased molecular weights resulting in the formation of more uniform fibers (46,47). Furthermore, the objective of this study was to manufacture carbon nanofibers and the inability to measure Tₛ reliably by FJ indicated that conversion of lignin nanofibers to oxidatively thermostabilized nanofibers may proceed very rapidly, especially in comparison to the low T_{g} lignins used for melt spinning.

Lignin molecular weights and their distributions were not measured for this study as it has previously been shown to be problematic, and instead relied on direct T_{g} and Tₛ measurements to establish the relationship between the two. Typically molecular weights are measured by first acetylating lignins to improve their solubility in common SEC solvents, and are then filtered prior to injection. This initial process assumes 1) quantitative recovery of modified lignin, 2) that no chemical changes within the lignin were made other than acetylation, 3) acetylation was uniform, and 4) acetylation provided a fully soluble lignin (insolubles will remain in the injection filter; gels may foul SEC columns). Once injected, the lignin is separated according to hydrodynamic volume on an assembly of columns with a solvent flow. Since lignin is a random heterogeneous polymer consisting of differing monomers, the reliability of such separations must be poor because of certain inherent features to be found within its structure, such as 1) a heterogeneous distribution of monolignols giving rise to differing solubility characteristics in, for example, THF; 2) the presence of some nanogel structure; 3) chain branching; 4) comparison of data to homogeneous, linear, well-defined polymers used as standards. However, relationships between molecular weight, T_{g}, and Tₛ have previously been suggested for lignins and other polymers

Comparison of the thermogravimetric analyses of SWKL and the purified derivative SWKL-P revealed an increase in the temperatures of both onset of decomposition (T_{d.onset}) and maximum rate of decomposition (T_{d.max}) due to purification (Table 3). This is most likely due to elimination of low molecular weight lignin components of lignin and hemicellulose contaminants. In addition to this, the char yield of SWKL-P (42.3%) was slightly increased compared to SWKL (42.0%), once values were corrected for ash content.

TABLE 3
Thermal properties of lignin samples

| | | | | | | | | Adjusted |
|---|---|---|---|---|---|---|---|---|
| | T_{g} | ΔCₚ | Tₛ | T_{f} | T_{d,onset} | T_{d,max} | Char | for ash |
| Lignin | (° C.) | (W/g) | (° C.) | (° C.) | (° C.) | (° C.) | (%) | (%) |
| SWKL | 148 | 0.311 | 184* | 199 | 276 | 366 | 43.6 | 42.0 |
| SWKL-P | 155 | 0.317 | 192 | 208 | 292 | 381 | 42.6 | 42.3 |
| SWKL-1 | 117 | 0.418 | 138 | 150 | 282 | 374 | 41.6 | 41.5 |
| SWKL-2 | 182 | 0.398 | 230 | 244 | 304 | 384 | 46.0 | 45.7 |

*Incomplete melt

The thermogravimetric analyses of SWKL and the purified derivative SWKL-P revealed an increase in the temperatures of both onset of decomposition (T_{d.onset}) and maximum rate of decomposition (T_{d.max}.) due to purification (Table 3). This is most likely due to elimination of a substantial quantity of salts and carbohydrates which can catalyze lignin decomposition. In addition to this, the char yield of SWKL-P (42.3%) was slightly increased compared to SWKL (42.0%), once values were corrected for ash content. In purified lignins, the main thermal mass loss occurs at temperatures around 360° C. and is due to the fragmentation of inter-unit bonds releasing monomeric phenols. Thermal decomposition then continues by cleavage of methyl-aryl ether bonds at about 400° C. and finally condensation of aromatic rings at 400-500° C. Therefore, the higher the molecular weight of the lignin and the more crosslinked it is, the lower the mass loss and the higher the temperature will be during thermolysis. Comparison of the thermal decomposition of the refined SWKL-2 to that of SWKL-P showed that the decomposition temperatures had increased to 384° C. and this must be because of its increased molecular weight (implied by relative T_{g} and Tₛ values) which would therefore result in less volatilization of material and a greater amount of crosslinking Their derivative weight loss curves (DTG; FIG. 2) also showed that both SWKL and SWKL-P had a fraction of lower molecular weight materials which were volatilized at about 190-240° C. This DTG shoulder was not observed for SWKL-2 (or for SWKL-1) which indicated that these volatile components were carbohydrate based which were reduced during purification and then completely removed during sequential solvent extraction. The char yield for SWKL-2 was 45.7% indicating improved thermal stability over SWKL-P, and for SWKL-1 it was 41.5% indicating a lower thermal stability due to increased volatilization of the lower molecular weight lignin.

### Electrospun Solution Concentration Dependence of Carbon Nanofibers

Preliminary investigations revealed that electrospinning solutions could be used to electrospray or electrospin SWKL-2 with concentrations in the region of 42.5% w/w. Solutions were therefore made with 35.7, 38.5, 41.7, 45.5 and 50.0% w/w. concentration for final sample preparation. These solutions were therefore of much higher concentration than those usually used for electrospinning of other polymers which are typically around 10 wt./v. One explanation for this could be that lignin molecular weights are very low, as suggested by GPC studies, and this allows for comparatively increased concentrations so that sufficient polymer chain entanglements are formed to increase viscosity. Furthermore, lignin is not linear, so it is possible that the MW is substantially higher, however the shape may not allow for solvation to occur with sufficient viscosity development. For electrospun fibers to be obtained there must be some additional interaction which allows lignin to coalesce and form fiber, and in this regard, some liquid crystalline behavior has been suggested to occur through Pi-electron cloud interaction.

Lignin solution concentration was found to have significant effects on the morphology of nanofibers formed and the resulting carbon nanofibers which were prepared under identical conditions (FIG. 3). At the lowest concentration (35.7% w/w.) the electrospun mat consisted of fibers with large beads interlinked with very fine ligaments (FIG. 2a), while a slightly increased concentration (38.5% w/w) resulted in elongated beads interlinked with fine fiber (FIG. 2b). A lignin concentration of 41.7% w/w. formed a uniform mat of medium diameter nanofibers without beads (FIG. 2c) and an increased concentration of lignin (45.5% w/w.); the highest used for continuous fiber mat production) resulted in increased fiber diameters (FIG. 2d), until solutions with 50.0% w/w. were unable to pass though the needle without coagulation on ejection. The diameter distributions of carbon nanofibers prepared from electrospinning solutions with concentrations of 41.7% w/w. and 45.5% w/w. are shown in FIGS. 2c and 2d, and there average diameters were found to be 343±128 nm and 769±129 nm, respectively. SEM images from a cross section of the carbonized electrospun mat derived from the 41.7% w/w. lignin solution showed that the carbon nanofibers had a uniform and regular cylindrical structure without any fiber bundles, defects, fusion or hollow structures (FIG. 4); The thickness of this mat was about 200 μm. Fiber diameters were therefore smaller and more uniform than those previously reported using lignin; and were comparable to electrospun carbon nanofibers manufactured from polyacrylonitrile (PAN).

The electrospun lignin solutions were therefore found to produce continuous electrospun filaments with a concentration range of 42.0±3.5% w/w. (or ±8.3%) which is unusually narrow in comparison to other polymers. The solution concentration and morphology dependence of electrospun fibers from many polymers has been studied by others who found a similar transition from beads to thick fibers, but over a much wider range of relative concentration. In electrospinning, an electrical potential difference between the orifice tip and grounded collector overcomes the polymer solution surface tension to form a linear liquid jet, after some distance it is stretched rapidly and bends violently in a region of electrical instability. This stretching of the solution jet in the instability region is the critical parameter in determining final fiber diameter and depends on the viscosity of the polymer solution. The final morphology of the fibers is therefore believed to be a result of two competing effects. At lower concentrations, the presence of fewer polymer chain entanglements leads to a lower surface tension and prevents stretching of the liquid jet which continuously breaks to form droplets of low concentration and therefore results in the formation of beads. At higher concentrations sufficient polymer chain entanglements allow the surface tension of the liquid jet to be great enough to allow rapid stretching during fiber formation.

### Conversion Rate Dependence of Lignin Nanofibers

Different heating rates during stabilization did not show any significant effect on morphology of the carbon nanofibers (FIG. 5). The SEM images of FIG. 5 are from solutions with a lignin derivative concentration of 41.7%, and were selected from the slowest to fastest heating rate. The surface of nanofibers from all selected stabilization rates were smooth, without defect or fusion. SEM images indicates that thermostabilization at all heating rates was successful and completely converted the thermoplastic lignin to thermoset, preventing fusion of fibers during carbonization, even at the fastest heating rate (20° C./min).

The thermal stability and thermal decomposition behavior of nanofibers stabilized at different rates analyzed by TGA were very similar (Table. 3). The TGA curves of stabilized nanofibers were covering each other and it was not possible to easily distinguish between them, therefore just the curve of one of the stabilization rates as an example were compared with green nanofibers (FIG. 6). The thermal decomposition temperature of nanofibers increased more than 100° C. after thermostabilization (Table 3). This increase was similar at all selected thermostabilization rates. Increases in thermal stability and thermal decomposition temperature of nanofibers after stabilization are due to cross-linking and condensation reactions which convert the lignin to a thermoset polymer and increasing T_{g} and thermal stability (53-55). Green fibers have a weight loss at about 210° C. which shows as an increase in the rate of weight loss in the DTG curve (FIG. 6). This weight loss was not observed in stabilized nanofibers and there is no decomposition below 300° C. in these samples. This decomposition also was not observed in TGA of extracted lignin sample and actually Td of green nanofibers was lower than extracted lignin sample. Parameter which could result in this difference can be less mass and much more surface area of nanofibers compared with lignin which facilitate volatile of residual low molecular weight components. Samples of the less mass but with a bigger surface area may lose mass at a faster rate. The weight loss at this temperature could be because of decomposition of low molecular weight phenols such as guaiacol or release of water by cleavage of hydroxyl groups in side chain of lignin (53). The maximum rate of weight loss for stabilized samples happened at temperature 50° C. higher than green nanofibers with lower rate compared to green nanofibers. Char yield also increased after stabilization which further confirms condensation and cross-linking in lignin which increase char and carbon yield (Table 3). The char yield was similar in all stabilized samples although it was slightly lower in nanofibers stabilized at the slowest heating rate.

Characterization of green and stabilized nanofibers by IR spectroscopy did not show significant difference between different stabilization rates (FIG. 6). The changes in functional groups of nanofibers after stabilization indicate structural changes of lignin due to heat and presence of oxygen (FIG. 7). The broad band at 3450 cm-1 is related to OH stretching of phenolic and aliphatic structure (56). The intensity of this band decreased after stabilization which was expected to increase due to formation of hydroxyl groups during oxidation (38). This decrease may indicate loss of some aliphatic groups containing OH during stabilization. The intensity of bands in region of 3000-2800 cm-1 which is related to C—H stretching of methyl and methylene groups of side chains (55) and methoxyl groups of aromatic rings (57) decreased after stabilization. Oxidation of alkyl groups and demethoxylation (58) have been reported as reactions which happen during oxidative thermostabilization and can decrease the intensity of bands in this region. The intensity of bands related to C═O stretching in carbonyl, unconjugated ketone and in ester groups (1730 cm-1) increased after stabilization. This is the main effect of up taking oxygen by lignin during oxidative stabilization. Formations of carbonyl and carboxyl groups are well known reactions in oxidative stabilization process and are followed by the formation of oxygen containing cross links as anhydride and ester linkages between lignin macromolecules.

The stabilization and carbonization yields show increased both steps when heating rate during stabilization was increased (Table 4).

TABLE 4
Thermal properties of nanofibers and oxidatively thermostabilized
nanofibers from 41.7% lignin solution measured by TGA.

| Stabilization | T_{d} | Char |
|---|---|---|
| rate (° C./min) | (° C.) | (%) |
| No treatment | 339 | 38.5 |
| 0.1 | 347 | 46.0 |
| 0.5 | 342 | 46.9 |
| 1 | 340 | 47.1 |
| 10 | 342 | 47.0 |
| 20 | 343 | 47.5 |

The difference between lowest heating rate and other selected heating rates was more and it had the lowest yields in both stabilization and carbonization steps. Yields were calculated for nanofibers from the two lignin solution concentration (41.7% and 45.5%) for confirmation of the results. Yields for nanofibers from both solution concentrations were almost the same although it was slightly higher for the higher concentration which could be because of the greater diameter of the nanofibers. Lower diameter fibers and higher surface areas can facilitate diffusion and gaining oxygen but can results in more weight loss due to excessive oxidation. Oxidative stabilization during the making of petroleum-based carbon fibers usually results in increases in weight due to the up taking oxygen and formation if carbonyl groups during cross-linking and condensation (42, 43, 44). Since lignin is already highly oxidized in side-chains and contains large number of hydroxyl groups the oxygen gain is not as much a petroleum-based polymers and mainly losses oxygen as dehydration and CO2 during condensation reactions (1, 4). This also could be also the reason for decrease in intensity of OH band in IR spectra of stabilized nanofibers.

Elemental analysis confirmed low oxygen gain of stabilized nanofibers and as presented carbon and hydrogen content slightly decrease during stabilization which indicates slightly increase in oxygen content of lignin during stabilization (Table 5).

TABLE 5
Yields in stabilization and carbonization steps for different
electrospun samples.

| | Yield after | | Yield after | |
|---|---|---|---|---|
| | stabilization (%) | | carbonization (%) | |
| Stabilization | 41.7% lignin | 45.5% lignin | 41.7% lignin | 45.5% lignin |
| rate (° C./min) | solution | solution | solution | solution |
| 0.1 | 67.9 | 68.7 | 33.7 | 34.7 |
| 0.2 | 73.1 | 74.1 | 36.5 | 37.4 |
| 0.5 | 75.5 | 78.5 | 38.9 | 40.1 |
| 1 | 77.2 | 79.0 | 37.7 | 39.0 |
| 3 | 78.9 | 81.4 | 39.1 | 40.4 |
| 5 | 78.5 | 80.7 | 38.9 | 40.8 |
| 10 | 78.7 | 81.2 | 41.0 | 42.0 |
| 20 | 79.2 | 80.9 | 40.2 | 41.8 |

The carbon content of stabilized nanofibers increased with increased heating rate which indicates slower heating rate results in higher oxygen gain. Slower heating rates resulted in increases in the period of oxidation and can increase oxygen gain but it also can increase weight loss if this rate be too slow (42, 44). The weight loss comes from decarboxylation and losing aromatic carbon in form of CO₂ and CO along with losing oxygen and hydrogen in form of H₂O (38, 42, 44). Oxygen continually absorbs during oxidation so decreases in carbon content is the most visible change in excessive oxidations. Losing aromatic carbons can cause defects and reduction in mechanical properties of carbon fibers (44). In selected oxidation rate it seems faster heating rate, shorter oxidation period, prevent excessive weight loss during stabilization and results in higher yield. Weight loss in usually happening in higher temperature and longer period of oxidation and have been reported in pitch-based carbon fibers (42, 44, 43)

An optimum stabilization period is necessary to prevent excessive oxidation and weight loss as a balance of oxygen gain and oxygen/carbon loss. Carbonization yields were also consistent with stabilization yields and were higher in samples stabilized at faster heating rate; it was especially lower for the slowest heating rates (0.1 and 0.2° C./min). The char yields of stabilized samples which were carbonized in TGA also were in agreement with these data in term of slightly higher char yields for higher heating rates (Table 3). An interesting finding was the difference between yields in TGA and furnace which was about 10% higher for all stabilized rates. The difference could possibly come from the huge difference in the volume of TGA and tube furnace which results in purging 10 cm3/min and 200 cm3/min nitrogen during carbonization in TGA and tube furnace, respectively. A much greater volume of nitrogen in tube furnace will increase chances for the presence of oxygen as contamination even in UHP nitrogen gas. Nanoscale diameter of carbon fibers also create a large surface are which increase accessibility of carbons to even trace amount of oxygen in nitrogen gas. The carbon content of carbonized samples showed the same trend as stabilized sampled and increased by stabilization heating rate (Table 5). The sulfur content also decreased during stabilization and its loss was along with duration of stabilization (Table 5). Although sulfur almost completely removed during carbonization but residual nitrogen was almost without change.

Overall it seems extracted and purified lignin has the ability to oxidize at a faster rate than reported previously for lignin (1, 21, 36, 38). Fast stabilization limited weight loss in both thermostabilization and carbonization steps and increased carbon yield as a result of preventing excessive oxidation. These stabilizations were performed on 200 μm nanofiber mat. Fast stabilization, in addition to reduction of time needed for production of carbon fibers (change the stabilization duration from a few days to about 1 hour), can also significantly decrease cost of production.

### Example 2

### Switchgrass Lignin Extraction

A lignin sample (60.42 g) was obtained from the organosolv fractionation of switchgrass (140° C./2 h/0.05 M)

Methanol extraction of this lignin gave 25.11 g (41.5%) of a low T_{g} derivative. The solid residue from the methanol extraction was then extracted with Methanol/Methylene chloride (70/30). The yield of lignin recovered from the second extraction was 24.80 g (41.0%). 5.04 g (8.34%) was also recovered as a solid residue on filter after drying.

### Electrospinning:

Electrospinning of the high-T_{g} extract of organosolv switchgrass lignin in DMF/methanol solution (75 to 25 wt %) was done at a lignin concentration of 45 w/w.

Similarly electrospinning of an organosolv lignin from poplar was done in DMF/methanol solution (75 to 25 wt %), at a lignin concentration of 55 w/w.

### Thermostabilization and Carbonization:

Electrospun samples of both poplar and switchgrass lignins were stabilized at heating rates of 0.1° C./min (and higher) to 250° C. and holding for 30 min.

Carbonization was performed as heating rate of 10° C./min to 950° C. and by holding for 2 min.

Carbonization yields were 28.3 and 23.7% for switchgrass and poplar derived samples, respectively. SEM micrographs of carbon nanofibers obtained from switchgrass are show in FIGS. 8-10.

### REFERENCES

1. Bozell, J. J. An evolution from pretreatment to fractionation will enable successful development of the integrated biorefinery. Bioresources 2010, 5, 1326-1327.
2. Pye, E. K.; Lora, J. H., The Alcell Process—a proven alternative to kraft pulping. TAPPI J., 1991, 74, 113-118.
3. Pan, X. J.; Arato, C.; Gilkes, N., Biorefining of softwoods using ethanol organosolv pulping: Preliminary evaluation of process streams for manufacture of fuel-grade ethanol and co-products., Biotechnol. & Bioeng., 2005, 90, 473-481.
4. Aziz, S.; Sarkanen, K., Organosolv pulping—a review. TAPPI J., 1989, 72, 169-175.
5. Johansson, A.; Aaltonen, O.; Ylinen, P., Organosolv pulping—methods and pulp properties. Biomass, 1987, 13, 45-65.
6. Gonzalez, R.; Treasure, T.; Phillips, R., Jameel, H.; Saloni, D. Economics of cellulosic ethanol production: green liquor pretreatment for softwood and hardwood, greenfield and repurpose scenarios. Bioresources, 2011, 6, 2551-2567.
7. Jin, Y. C.; Jameel, H.; Chang, H. M.; Phillips, R. Green liquor pretreatment of mixed hardwood for ethanol production in a repurposed kraft pulp mill. J. Wood. Chem. Technol., 2010, 30, 86-104.
8. Van Heiningen, A., Converting a kraft pulp mill into an integrated forest biorefinery. Pulp & Paper-Canada, 2006, 107, 38-43.
9. Huang, H-J.; Ramaswamy, S.; Al-Dajani, W. W. Process modeling and analysis of pulp mill-based integrated biorefinery with hemicellulose pre-extraction for ethanol production: a comparative study. Bioresource Technol., 2010, 101, 624-631.
10. Kadla, J. F.; Kubo, S.; Venditti, R. A.; Gilbert, R. D.; Compere, A. L.; Griffith, W., Lignin-based carbon fibers for composite fiber applications. Carbon 2002, 40 (15), 2913-2920.
11. Kubo, S.; Kadla, J. F., Lignin-based Carbon Fibers: Effect of Synthetic Polymer Blending on Fiber Properties. Journal of Polymers and the Environment 2005, 13 (2), 97-105.
12. Sudo, K.; Shimizu, K., A new carbon fiber from lignin. Journal of Applied Polymer Science 1992, 44 (1), 127-134.
13. Uraki, Y.; Kubo, S.; Nigo, N.; Sano, Y.; Sasaya, T., Preparation of carbon-fibers from organosolv lignin obtained by aqueous acetic-acid pulping. Holzforschung 1995, 49 (4), 343-350.
14. Baker, D. A.; Gallego, N. C.; Baker, F. S., On the characterization and spinning of an organic-purified lignin toward the manufacture of low-cost carbon fiber. Journal of Applied Polymer Science 2012, 124 (1), 227-234.
15. Huang, Z. M.; Zhang, Y. Z.; Kotaki, M.; Ramakrishna, S. A review on polymer nanofibers by electrospinning and their applications in nanocomposites. Comp. Sci. Technol., 2003, 63, 2223-2253.
16. Pham, Q. P.; Sharma, U.; Mikos, A. G. Electrospinning of polymeric nanofibers for tissue engineering applications: A review. Tissue Eng., 2006, 12, 1197-1211.
17. Teo, W. E.; Ramakrishna, S. A review on electrospinning design and nanofiber assemblies. Nanotech., 2006, 17, R89-R106.
18. Schiffman, J. D.; Schauer, C. L. A review: Electrospinning of biopolymer nanofibers and their applications., Polym. Rev., 2008, 48, 317-352.
19. Ye, C. S. et. al., “The performance of electropositive nanofibrous filter media”, Desalination, 270, 188-192 2011
20. Lee, D. J., Kim, H. M. et al. “Water droplet bouncing and superhydrophobicity induced by multiscale hierarchical nanostructures”, ACS Nano 6 7656-7664 2012
21. Kim, B. H., Yang, K. S. and Ferraris, J. P., “Highly conductive, mesoporous carbon nanofiber web as electrode material for high-performance supercapacitors”, Electrochim. Acta 75, 325-331 2012
22. Balan, B. K. and Kurungot, S., “Tuning the functionality of a carbon nanofiber-Pt-RuO₂ system from charge storage to electrocatalysis”, Inorg. Chem. 51, 9766-9774 2012
23. Yu, J. et al., “Determination of carbon nanofiber morphology in vinyl ester nanocomposites”, J. Composite Mater. 46, 1943-1953 2012
24. Oh, S. I. et al., “Fabrication of carbon nanofiber reinforced aluminum alloy nanocomposites”, J. Alloys & Comp., 542 111-117 2012
25. Baker, D. A.; Harper, D. P.; Bozell, J. J. Rapid manufacture of carbon fiber from organosolv lignins. Extended abstract in Book of Abstracts of The Fiber Society 2011 Fall Conference, Charleston, S.C., USA, October, 2011. http://www.thefibersociety.org/Assets/Past_Meetings/PastMtgs_Home.html
26. Lallave, M.; Bedia, J.; Ruiz-Rosas, R.; Rodriguez-Mirasol, J.; Cordero, T.; Otero, J. C.; Marquez, M.; Barrero, A.; Loscertales, I. G. Filled and hollow carbon nanofibers by coaxial electrospinning of Alcell lignin without binder polymers. Adv. Mater., 2007, 19, 4292-4296.
27. Reneker, D. H.; Yarin, A. L. Electrospinning jets and polymer nanofibers. Polymer, 2008, 49, 2387-2425.
28. Ruiz-Rosas, R.; Bedia, J.; Lallave, M. Loscertales, I. G.; Barrero, A.; Rodriguez-Mirasol, J.; Cordero, T. The production of submicron diameter carbon fibers by the electrospinning of lignin. Carbon, 2010, 48, 696-705.
29. Dallmeyer, I.; Ko, F.; Kadla, J. F. Electrospinning of technical lignins for the production of fibrous networks. J. Wood. Chem. Technol., 2010, 30, 315-329.
30. Seo, D. K.; Jeun, J. P.; Kim, H. B.; Kang, P. H. Preparation and characterization of the carbon nanofiber mat produced from electrospun PAN/lignin precursors by electron beam irradiation. Rev. Adv. Mater. Sci., 2011, 28, 31-34.
31. Bozell, J J., C. J. O'Lenick, S. Warwick, Biomass fractionation for the biorefinery: HMQC-NMR investigation of lignin isolated from solvent fractionation of switchgrass, J. Agric. Food Chem., 2011, 59, 9232-9242.
32. Cedeno, D.; Bozell, J. J. Catalytic oxidation of para-substituted phenols with cobalt-Schiff base complexes/O-2-selective conversion of syringyl and guaiacyl lignin models to benzoquinones. Tetrahedron Letters, 2012, 53, 2380-2383.
33. Baker, D. A. Recent advances in low-cost carbon fiber manufacture from lignin. J. Appl. Polym. Sci. 2013, Invited review—submitted for review.
34. Hosseinaei, O.; Baker, D. A. Electrospun carbon nanofibers from kraft lignin. Extended abstract in Book of Abstracts of The Fiber Society 2012 Fall Conference, Boston Convention & Exhibition Center, Boston, Mass., USA, Nov. 7-9, 2012. http://www.thefibersociety.org/Assets/Past_Meetings/PastMtgs_Home.html
35. Mörck, R.; Yoshida, H.; Kringstad, K. P.; Hatakeyama, H., Fractionation of kraft lignin by successive extraction with organic solvents. 1. Functional groups (13)C-NMR-spectra and molecular weight distributions. Holzforschung 1986, 40, 51-60.
36. NREL, Determination of ash in biomass. NREL/TP-510-42622, National Renewable Energy Laboratory, 2008.
37. NREL, Determination of structural carbohydrates and lignin in biomass. NREL/TP-510-42618, National Renewable Energy Laboratory, 2010.
38. Kline, L. M.; Hayes, D. G.; Womac, A. R.; Labbe, N. Simplified determination of lignin content in hard and soft woods via UV-spectrophotometric analysis of biomass dissolved in ionic liquids. BioResources 2010, 5, 1366-1383.
39. Labbe, N.; Kline, L. M.; Moens, L.; Kim, K.; Kim, P. C.; Hayes, D. G., Activation of lignocellulosic biomass by ionic liquid for biorefinery fractionation. Biores. Technol., 2012, 104, 701-707.
40. Kim, P. C.; Johnson, A., Edmunds, C. W.; Radosevich, M.; Vogt, F.; Rials, T. G.; Labbe, M. Surface functionality and carbon structures in lignocellulosic-derived biochars produced by fast pyrolysis. Energy & fuels, 2011, 25, 4693-4703.
41. Martens, H.; Naes, T. Multivariate Calibration. Wiley, New York. 1989.
42. Yoshida, H.; Morck, R.; Kringstad, K. P.; Hatakeyama, H., Fractionation of kraft lignin by successive extraction with organic-solvents 0.2. thermal-properties of kraft lignin fractions. Holzforschung 1987, 41 (3), 171-176.
43. Hatakeyama, H.; Iwashita, K.; Meshitsuka, G.; Nakano, J., Effect of molecular weight on glass transition temperature of lignin. Mokuzai Gakkaishi 1975, 21 (11), 618-623.
44. Fox, J. T. G.; Flory, P. J., Second-Order Transition Temperatures and Related Properties of Polystyrene. I. Influence of Molecular Weight. J. Appl. Phys. 1950, 21 (6), 581-591.
45. Larrain, R.; Tagle, L. H.; Diaz, F. R., Glass transition temperature-molecular weight relation for poly(hexamethylene perchloroterephthalamide). Polymer Bulletin 1981, 4 (8), 487-490.
46. Gupta, P.; Elkins, C.; Long, T. E.; Wilkes, G. L., Electrospinning of linear homopolymers of poly(methyl methacrylate): exploring relationships between fiber formation, viscosity, molecular weight and concentration in a good solvent. Polymer 2005, 46 (13), 4799-4810.
47. Tan, S. H.; Inai, R.; Kotaki, M.; Ramakrishna, S., Systematic parameter study for ultra-fine fiber fabrication via electrospinning process. Polymer 2005, 46 (16), 6128-6134.
48. Kubo, S.; Uraki, Y.; Sano, Y., Thermomechanical analysis of isolated lignins. Holzforschung 1996, 50 (2), 144-150.
49. Doshi, J.; Reneker, D. H., Electrospinning process and applications of electrospun fibers. Journal of Electrostatics 1995, 35 (2-3), 151-160.
50. Deitzel, J. M.; Kleinmeyer, J.; Harris, D.; Beck Tan, N. C., The effect of processing variables on the morphology of electrospun nanofibers and textiles. Polymer 2001, 42 (1), 261-272.
51. Kim, C.; Yang, K. S.; Kojima, M.; Yoshida, K.; Kim, Y. J.; Kim, Y. A.; Endo, M., Fabrication of Electrospinning-Derived Carbon Nanofiber Webs for the Anode Material of Lithium-Ion Secondary Batteries. Advanced Functional Materials 2006, 16 (18), 2393-2397.
52. Inagaki, M.; Yang, Y.; Kang, F., Carbon Nanofibers Prepared via Electrospinning Advanced Materials 2012, 24 (19), 2547-2566.
53. Brodin, I.; Ernstsson, M.; Gellerstedt, G.; Sjöholm, E., Oxidative stabilisation of kraft lignin for carbon fibre production. Holzforschung 2012, 66 (2), 141-273.
54. Brodin, I.; Sjöholm, E.; Gellerstedt, G., The behavior of kraft lignin during thermal treatment. Journal of Analytical and Applied Pyrolysis 2010, 87 (1), 70-77.
55. Braun, J. L.; Holtman, K. M.; Kadla, J. F., Lignin-based carbon fibers: Oxidative thermostabilization of kraft lignin. Carbon 2005, 43 (2), 385-394.
56. Faix, O., Classification of Lignins from Different Botanical Origins by FT-IR Spectroscopy. Holzforschung 1991, 45 (s1), 21-28.
57. Sharma, R. K.; Wooten, J. B.; Baliga, V. L.; Lin, X.; Geoffrey Chan, W.; Hajaligol, M. R., Characterization of chars from pyrolysis of lignin. Fuel 2004, 83 (11-12), 1469-1482.
58. Foston, M.; Nunnery, G. A.; Meng, X.; Sun, Q.; Baker, F. S.; Ragauskas, A., NMR a critical tool to study the production of carbon fiber from lignin. Carbon (0).

What is claimed is:

1. A composition comprising a lignin derivative derived from a lignin source material and having a glass transition temperature (T_{g}) of at least 130° C.

2. The composition of claim 1, wherein the glass transition temperature is at least 155° C.

3. The composition of claim 1, wherein the lignin derivative has an ash content of between approximately 0.01% and approximately 0.60%.

4. The composition of claim 1, wherein the ash content is less than 1.00%, less than 0.60%, less than 0.50%, less than 0.40%, less than 0.30%, less than 0.20%, or less than 0.10%.

5. The composition of claim 1, wherein the lignin source material is derived from a pulping process of a lignin feedstock material, wherein the lignin feedstock material is a softwood lignin feed stock material, a hardwood lignin feedstock material, an annual fiber feedstock material, or a combination thereof

6. The composition of claim 1, wherein the lignin feedstock material is switchgrass, poplar, pine, or a combination thereof.

7. The composition of claim 1, wherein the pulping process is a kraft pulping process or an organosolv pulping process.

8. A method for making lignin derivatives from lignin source materials, the method comprising:
washing a lignin source material with water or acidified water to generate a purified lignin portion;
extracting the purified lignin portion with a solvent to generate a lignin derivative extract, wherein the solvent comprises methanol, methylene chloride, dimethyl formamide, dimethyl acetamide, ethanol, propanol, diethyl ether methanol, or a combination thereof; and
filtering and recovering the lignin derivative extract to generate a final lignin derivative.

9. A lignin derivative made according to the method of claim 8.

10. A method for making lignin derivatives from lignin source materials, the method comprising:
washing a lignin source material with water or acidified water to generate a purified lignin portion;
extracting the purified lignin portion with a first solvent to generate a first purified lower T_{g} lignin extract contained in the first solvent;
filtering and recovering the first purified lignin extract to generate a lower T_{g} lignin derivative,
extracting the lower T_{g} lignin derivative with a second solvent to generate a second lignin derivative extract; and
filtering and recovering the second lignin derivative extract to generate a high T_{g} lignin derivative, wherein the final lignin derivative has a higher T_{g} than the low T_{g} lignin derivative.

11. The method of claim 10, wherein the first solvent comprises methanol, methylene chloride, dimethyl formamide, dimethyl acetamide, ethanol, propanol, diethyl ether methanol, or a combination thereof.

12. The method of claim 10, wherein the second solvent comprises methanol, methylene chloride or a mixture thereof.

13. The method of claim 10, wherein the second solvent comprises a 70/30 v/v methanol to methylene chloride mixture

14. A lignin derivative made according to the method of claim 10.

15. A method of making carbon nanofibers from the composition of claim 1, the method comprising:
electrospinning a concentration of the lignin derivative dissolved in an electrospinning solution to generate lignin nanofibers;
thermostabilizing the lignin nanofibers; and
carbonizing the lignin nanofibers to generate carbon nanofibers.

16. The method of claim 15, further comprising graphitizing the carbon nanofibers to generate graphite nanofibers.

17. The method of claim 15, wherein the electrospinning solution comprises 75% dimethylformamide and 25% methanol.

18. The method of claim 15, wherein the concentration of lignin derivative is between 40% and 50%.

19. The method of claim 15, wherein the concentration of lignin derivative is approximately 42%.

20. The method of claim 15, wherein the carbon nanofibers have a diameter of between 25 nm and 5 microns.

21. The method of claim 15, wherein the carbon nanofibers are in the form of a carbon nanofibers mat.

22. The method of claim 21, wherein the carbon nanofibers mat has a thickness of between 100 μm to 500 μm.

23. The method of claim 15, wherein the lignin nanofibers are thermostabilized by heating the lignin derivatives to a temperature between 160 to 250° C. at a rate between 0.1 and 100° C./min.

24. The method of claim 15, wherein the lignin nanofibers were carbonized by heating to at temperature between 800 to 1250° C. at a rate of 10° C./min and holding for 2 minutes.

25. A carbon nanofibers made from the method of claim 15.

26. A composition comprising carbon nanofibers, the carbon nanofibers comprising the lignin derivative of claim 1.
